(19) United States
(12) Patent Application Publication
(10) Pub. No.: US 2021/0123274 A1
(43) Pub. Date: Apr. 29, 2021

(54) DOOR RESTRAINT

(71) Applicant: Colton JAMES, Centerville, UT (US)

(72) Inventor: Colton JAMES, Centerville, UT (US)

(21) Appl. No.: 17/078,597

(22) Filed: Oct. 23, 2020

Related U.S. Application Data
(60) Provisional application No. 62/926,200, filed on Oct. 25, 2019.

(51) Int. Cl. E05C 19/18; E05C 17/54; E05C 19/00

(52) U.S. Cl. CPC E05C 19/184; E05C 19/003; E05C 17/54

(57) ABSTRACT

A door restraint device includes a support bar and a strap. The support bar is configured to be arranged horizontally and extend across and be supported against a door frame proximate a handle of a door positioned in the door frame. The strap is connected to the support bar and sized to connect to a handle of the door.

### CROSS-REFERENCE TO RELATED APPLICATIONS

This application claims priority to U.S. Patent Application No. 62/926,200 entitled “DOOR RESTRAINT,” filed Oct. 25, 2019, which is incorporated herein in its entirety by this reference

### TECHNICAL FIELD

The present disclosure is directed to door restrain devices and systems, and more particularly to door restraint devices and systems configured to hold a door closed from inside a room when the door swings away from the room to open, or at a minimum to present unwanted entry into a room through a doorway by an intruder.

### BACKGROUND

As the result of an unfortunate number of situations in which an intruder has entered a school building or commercial building with a firearm or other weapon, there is a need to be able to quickly secure a classroom or other door against intrusion. Various methods have been suggested that require modifications to the building or door structures. Other methods require the existing door latch be set to a “locked” setting and prevent the door from latching completely until the device is disengaged.

Applicable fire safety requirements are of particular concern for devices that prevent the opening of a doorway used in public buildings such as schools. In order to be compliant with many such standards, an occupant of a locked room must be able to exit the room. Further, there are some requirements for the secured door to be accessible by law enforcement from outside the room in the event the intruder has barricaded himself in that room. There is a need for a device that secures a doorway and can easily be added to an existing door without significant modification of the door or building structure.

### SUMMARY

The present invention is an apparatus, system and method for quickly securing a door to a door frame to protect the occupants of a room from an intruder. Such a system ideally should not require additional components that must be added to the door during use and ideally should not require more than a single movement to engage. In order to comply with fire code requirements, the system preferably should not require more than a single movement to open the door in the event of a fire or other circumstance in which the secured area must be evacuated.

The disclosed devices address these and other preferred criteria. In one example, a door restrain device in accordance with the present disclosure may permit a user to open the door from within the secured room with a minimum of movements and time in the event of a dangerous situation in the room such as fire or other hazards. Embodiments of the disclosure are primarily applicable to doors that open outwardly relative to an area to be secured. Some embodiments are capable of being released from outside of the area to be secured.

One aspect of the present disclosure relates to a door restraint device that includes a support bar and a strap. The support bar is configured to be arranged horizontally and extend across and be supported against a door frame proximate a handle of a door positioned in the door frame. The strap is connected to the support bar and sized to connect to a handle of the door.

The door restraint device may further include at least one bar retention member mounted to the support bar and configured to secure the support bar to the door frame. The at least one bar retention member may include magnetic material. The at least one bar retention member may include a first magnet positioned at a first end of the support bar and a second magnet positioned at an opposite second end of the support bar. The strap may have a loop shape. The strap may be connected to the support bar with a fastener. The support bar may have a hollow construction. The support bar may include a metal material. The strap may include a fabric material. The strap may include a buckle that provides length adjustment for the strap.

A further aspect of the present disclosure relates to a door restraint device that includes an elongate metal bar, first and second magnets, and a strap. The first and second magnets are mounted to the bar and configured to releasably secure the bar to respective right and left sides of a metal door frame when the bar is oriented horizontally across a width of the door frame. The strap is connected to the bar and configured to wrap around a door handle of a door that is mounted to and arranged in a closed position relative to the door frame. The door restrain device is configured to limit opening of the door in a first direction.

The door restraint device may also include a foot member mounted to a first end of the metal bar and a handle fork mounted to a second end of the bar, and the foot member may be configured to engage a floor surface and the handle fork configured to engage the door handle to restrict opening of the door in a second direction. The strap may have a fixed length.

Another aspect of the present disclosure relates to a method of operating door restraint device. The method includes providing a door restraint device having a cross bar, a handle connecting member mounted to the bar, and at least one bar retention member connected to the bar, orienting the cross bar across a width of a door frame, securing the cross bar to opposite sides of the door frame with the at least one bar retention member, and connecting the handle connecting member to a handle of the door.

The at least one bar retention member may be a magnet, and securing the cross bar to the door frame may include releasably connecting the magnet to the door frame. The handle connecting member may include a loop of material, and connecting the handle connecting member to the handle may include positioning a portion of the handle connecting member around a free end of the handle. The handle connecting member may include a strap, and connecting the handle connecting member to the handle may include wrapping a portion of the handle connecting member around the handle. The handle connecting member may include a bracket arranged to limit rotation of the handle in at least one direction to present unlatching of the handle. The method may further include adjusting a length of the cross bar before securing cross bar to the door frame. The method may include adjusting a length of the handle connecting member after connecting the handle connecting member to the door handle to adjust an amount the door is openable relative to the door frame.

### BRIEF DESCRIPTION OF THE DRAWINGS

The accompanying drawings and figures illustrate a number of exemplary embodiments and are part of the specification. Together with the present description, these drawings demonstrate and explain various principles of this disclosure. A further understanding of the nature and advantages of the present invention may be realized by reference to the following drawings. In the appended figures, similar components or features may have the same reference label.

FIG. 1 is a front perspective view of an example door restraint device in accordance with the present disclosure.

FIG. 2 is a rear perspective view of the door restraint device shown in FIG. 1.

FIG. 3A is a perspective view of the door restraint device of FIG. 1 mounted to a door frame and door handle in accordance with the present disclosure.

FIG. 3B is a perspective view showing the door restraint device of FIG. 1 mounted to a door frame and disconnected from the door handle in accordance with the present disclosure.

FIG. 4 is a perspective view of another example of a door restraint device in accordance with the present disclosure mounted to a door frame and door handle.

FIG. 5 is a perspective view of another example of a door restraint device in accordance with the present disclosure.

FIG. 6 is a perspective view of another example of a door restraint device in accordance with the present disclosure mounted to a door frame and door handle.

FIG. 7A is a perspective view of another example of a door restraint device in accordance with the present disclosure.

FIG. 7B is an exploded perspective view of the door restraint device shown in FIG. 7A.

FIG. 8 is a perspective view of the door restraint device shown in FIG. 7A mounted to a door handle in accordance with the present disclosure.

FIG. 9 is a perspective view of another example of a door restraint device in accordance with the present disclosure mounted to a double door frame and two door handles in accordance with the present disclosure.

FIG. 10 is a perspective view of another example of a door restraint device in accordance with the present disclosure.

FIG. 11 is a perspective view of an adjustable length strap for use with the door restraint device as disclosed herein.

FIGS. 12A-12D are end views of alternative bar designs for use with the door restraint device as disclosed herein.

While the embodiments described herein are susceptible to various modifications and alternative forms, specific embodiments have been shown by way of example in the drawings and will be described in detail herein. However, the exemplary embodiments described herein are not intended to be limited to the forms disclosed. Rather, the instant disclosure covers all modifications, equivalents, and alternatives falling within the scope of the appended claims.

### DETAILED DESCRIPTION

The present disclosure relates to door restraint devices, such as a device used to maintain a door closed in the event of a hostile intruder situation. One application for the present door restraint device is with a school classroom door. School classroom doors typically open into the hallway. Thus, it is sometimes difficult to maintain the door closed, particularly when there are rules related to how a classroom door can be locked related to fire code requirements and state statutes related to the need to be able to open a door from the hallway side even in the event of a hostile intruder (e.g., when an active shooter is inside the classroom).

The door restraint devices disclosed herein may be relatively simple to use, particularly for someone familiar with the device. In some applications, it may take less than 10 seconds to activate or deactivate the device related to properly securing the door in a locked position. The door restraint may include a strap or other connecting member that engages the door handle. The strap may have a fixed length. This fixed length may permit opening the door relative to the frame in an amount needed for someone in the hall (outside the classroom) to cut or break the strap in order to gain access to the classroom, but prevent the door from being opened enough for a person to pass through the doorway into the room. In other embodiments, the strap or connector has an adjustable length that ranges from a length that holds the door in a tightly closed position to a length that permits opening of the door relative to the door frame in variable amounts (preferably in an amount that is less than what would be required for a typical sized person to pass through the doorway into the room).

The door restraints may comprise different colored materials to make it easier to keep track of the device and identify in stressful hostile intruder situations, drills, and the like. The device may be mounted directly to a door frame when not in use securing the door in the closed position. For example, the device may include one or more magnets, an adhesive, a bracket, or the like that is used to secure the restraint to a side of the door frame or along the top of the door frame when not in use. The same or similar features used to hold the restraint to the door frame when not in use may be used to hold the restraint in place when in use holding the door closed.

Aspects of the disclosure are initially described below in the context of door restraint devices and systems, and related methods of use. Various examples of the door restraint devices and systems are described. These and other aspects of the disclosure are further illustrated by and described with reference to schematic apparatus drawings.

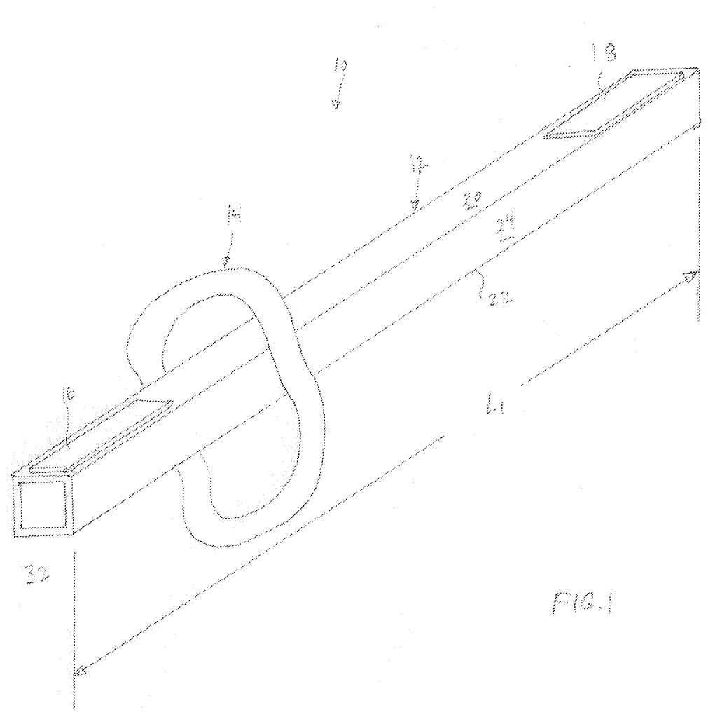

FIG. 1 schematically illustrates a door restraint 10 that includes a bar 12, a strap 14 and first and second bar retention members 16, 18. The bar 12 includes front and rear surfaces 20, 22, left and right side surfaces 24, 26, first and second ends 28, 30 and a length L₁. Typically, the first and second bar retention members 16, 18 are positioned at or near the first and second ends 28, 30, respectively. The length L₁ typically is long enough to extend across a door frame when the bar 12 is arranged horizontally. In use, the bar 12 typically extends across the door frame and is secured to the door frame with the first and second bar retention members 16, 18. The bar 12 is positioned at a height relative to the floor to position the strap 14 in proximity to a handle mounted to the door. The strap 14 can be wrapped around and engages the handle. The door restraint 10 is particularly useful with door handles that are standard for classrooms, such as door handles that include a free end extending horizontally such that the strap can be looped over the free end and restrain movement of the door when pivoting about its hinges.

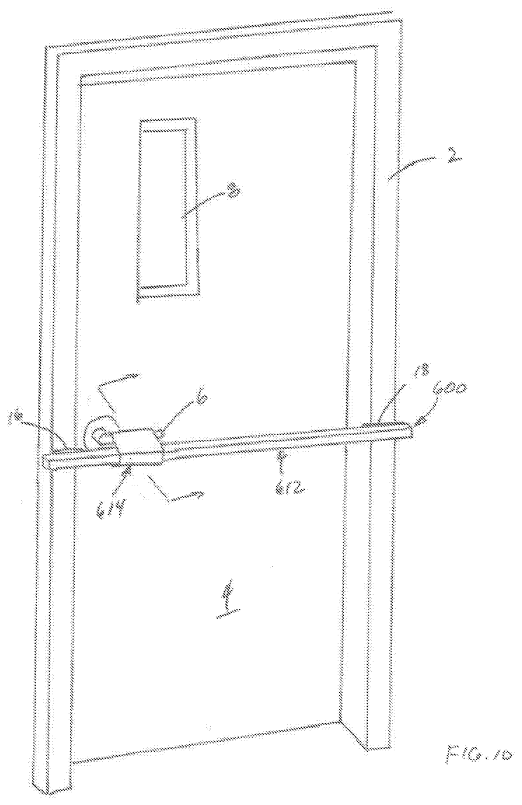

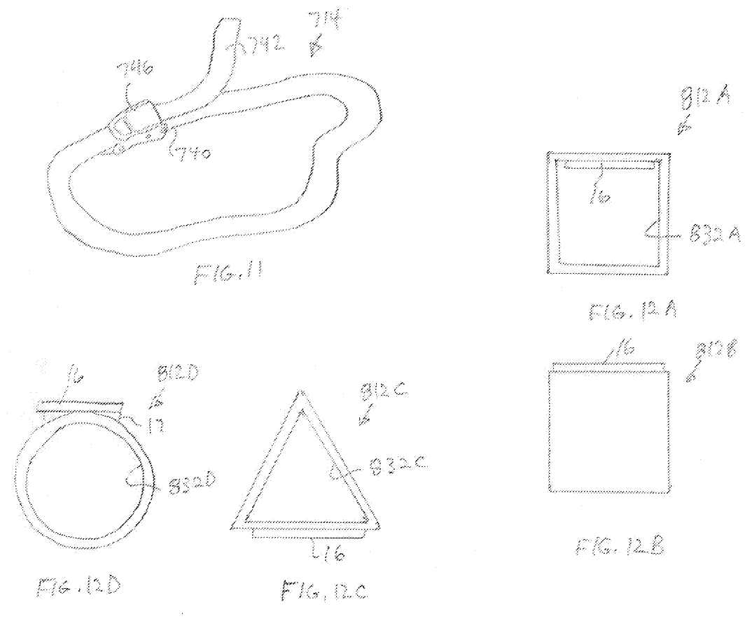

The bar 12 is shown having a square cross sectional shape. Other cross sectional shapes are possible including, for example, the triangular and circular cross sectional shapes shown in FIGS. 12C and 12D. Further, the bar 12 is shown having a hollow construction with a hollow cavity 32. Alternatively, the bar 12 may have a solid construction such as shown in FIG. 11B. Providing the bar 12 with at least one planer surface may have certain advantages related to mounting the door restraints to a door frame, which typically has planer surfaces to which the bar 12 is mounted. However, the bar 12 may have any desired shape (including cross-sectional shape) and size. Other cross-sectional shapes include rectangular, oval and polygonal (i.e., with more than four sides—hexagonal, pentagonal, octagonal, or the like).

The bar 12 may comprise a relatively rigid material. For example, the bar may comprise a metallic material such as steel. Other types of material may be used such as, for example, wood, fiberglass, composite materials, polymer materials, laminate materials and the like. The material selected may provide a balance between weight, strength, durability, and other properties. Some types of materials may be better suited for a particular cross-sectional shape of the bar 12.

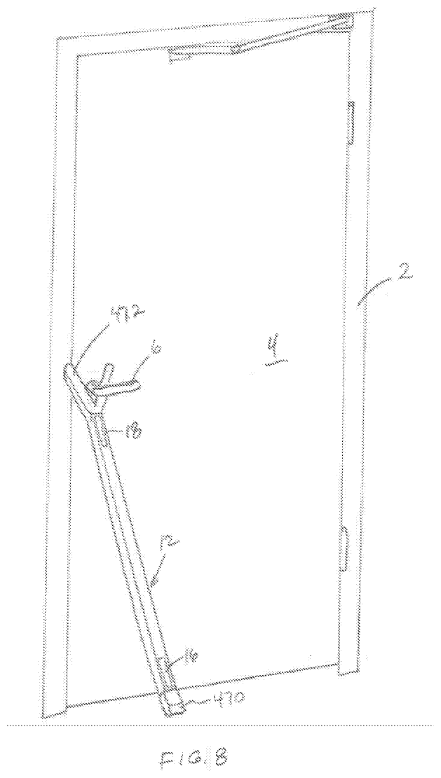

The bar 12 typically has a length L₁ sufficient to span across the width of a door frame for the door being restrained by the door restraint device 10. Standard classroom doors typically have a door opening width in the range of about 32 to about 42 inches, and particularly about 36 inches inside the door frame (and about 40-44 inches on the outside of the door frame). The length L₁ typically is a few inches greater than the door opening width, such as a length in the range of about 36 to about 42 inches, but more preferably a length that is greater than the width of the standard door or range of standard doors by 5%-10%. In other embodiments, the length L₁ may be sufficient for the bar 12 to extend across a set of double doors (e.g., French style doors) with an opening that has a total width in the range of about 70 inches to about 80 inches, thus requiring a length L₁ also in the range of at least 70 inches to at least 80 inches. An example of a double door is described below with reference to FIG. 9.

The bar 12 may be secured to the door frame using the first and second bar retention members 16, 18, the bar retention members may have variety of different shapes, sizes and material properties. In one example, the bar retention members 16, 18 comprise a magnetic material that provides a releasable magnetic connection between the bar 12 and the door frame. In another example, the bar retention members 16, 18 comprise an adhesive material such tape, putty, bonding agent, or the like. In one example, the bar retention members 16, 18 comprise a two-sided tape that is covered with a protective layer that can be removed to expose an adhesive surface used to secure the bar 12 to the door frame.

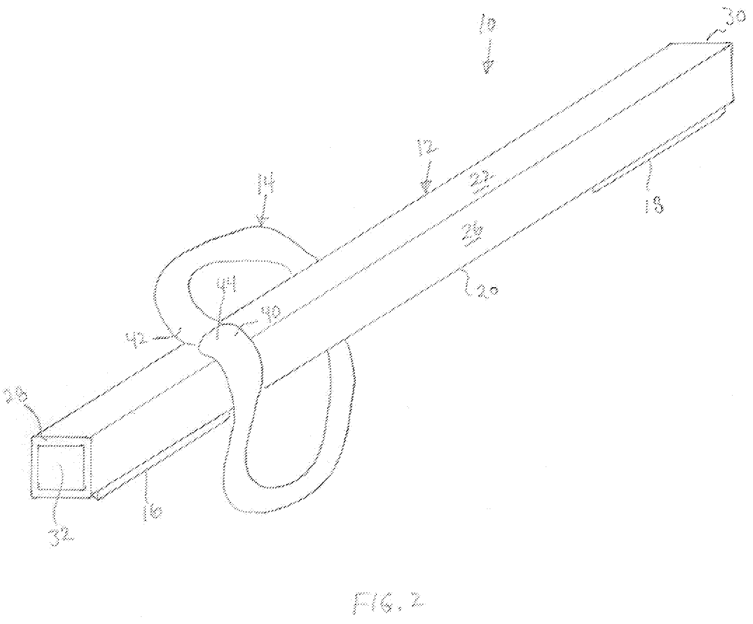

The bar retention members 16, 18 may have any desired shape and size. The bar retention members 16, 18 shown in FIGS. 1 and 2 have a rectangular shape, are relatively elongate, and extend along a portion of a length dimension at the bar 12. The bar retention members 16, 18 may have a length that provides securing the bar 12 to door frames having a wide range of widths, and may have a relatively long length so as to permit some adjustability in how the bar 12 is mounted to the door frame in a horizontal direction (i.e., a perfect alignment of the bar 12 with the door frame may not be required so long as the bar retention members 16, 18 at least partially engage the door frame). In other embodiments, the bar retention members 16, 18 have a relatively small size such as a small dot or relatively small magnet (e.g., a coin-shaped magnet). Such relatively small sized bar retention members may require a more precise alignment of the bar retention members with the door frame when mounting the bar 12 to the door frame.

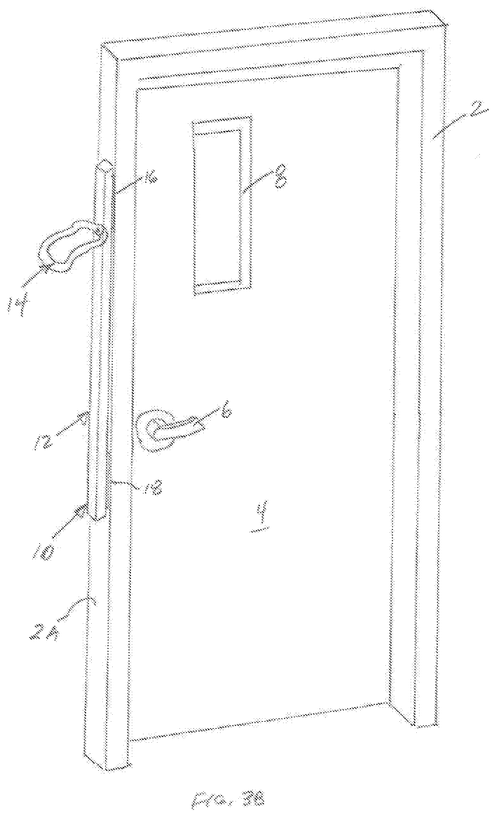

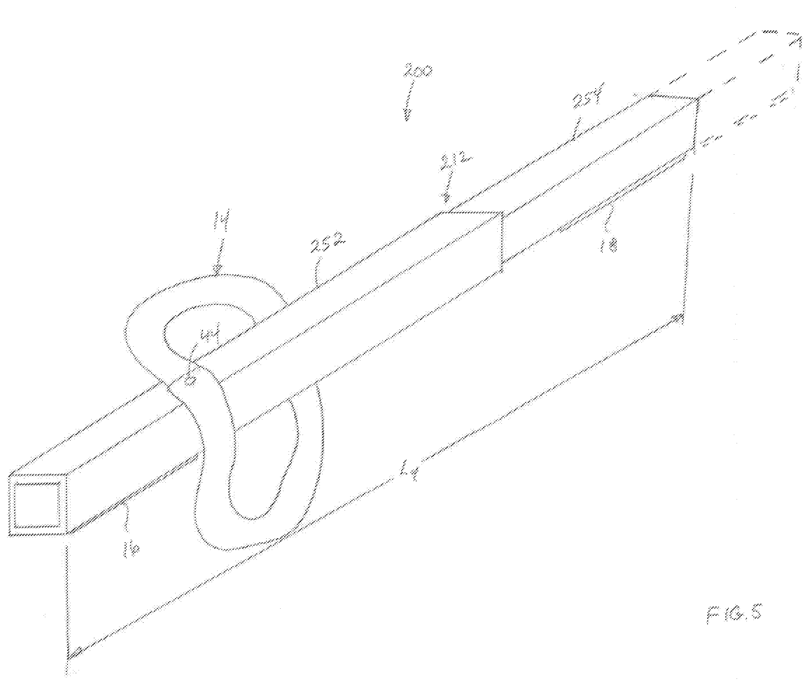

Other types of bar retention members may be used such as, for example, the bracket described below with reference to FIG. 6. Alternatively, the bar 12 may be supported by a support leg against the ground surface rather than being mounted to the door frame as described below with reference to the embodiment of FIG. 4.

The strap 14 may have a variety of shapes and sizes and comprise different types of material. In one example, the strap 14 comprises a fabric material such as nylon, polyester, or resin-coated polymers. Other materials include leather, rubber and flexible metallic materials such as a braided cable. The strap 14 may comprise a rope-like material and/or have a rope construction.

The strap 14 may be secured to the bar 12 using a variety of different connection arrangements. FIG. 2 illustrates the strap 14 mounted to the bar 12 using a fastener 44. The fastener may comprise a screw, bolt, rivet, or the like. In some arrangements, the strap 14 may include the first and second ends 40, 42 that are secured to the bar 12 and to each other using the fastener 44. In other arrangements, separate fasteners 44 may be used to secure each of the free ends 40, 42 separately to the bar 12. Alternatively, multiple fasteners may be used to secure one or both of the first and second free ends 40, 42 to the bar 12. In other examples, the strap 14 is pre-formed as a continuous loop and secured to the bar 12 at a single location using the fastener 12. FIG. 2 shows the strap 14 mounted to the bar 12 along the rear surface 22 and the first and second retention members 16, 18 are mounted to the front surface 20 on the side of the bar opposite from each other. The strap 14 may be secured to any one of the surfaces 20, 22, 24, 26 of the bar 12. Securing along the rear surface 22 may have certain advantages related to maximizing the strength possible in securing the door in a closed end.

In other arrangements, the strap 14 is secured to the bar 12 using a different material or method besides a fastener. For example, an adhesive, welding, heat welding, brackets, retention strap or rope, a clip or the like may be used to secure the strap 14 to the bar 12, particularly depending on the type of material used for the strap 14. In still other examples, the strap 14 is not secured to the bar 12 at all. In one example, the strap 14 is provided as a continuous loop, the bar 12 is inserted through the loop and mounted to the door frame, and the strap 14 is secured to the door handle and supported by the bar 12. Pre-securing the strap 14 to the bar 12 may have advantages associated with keeping the components of the door restraint 10 together at all times (such as when not in use securing the door closed) and/or positioning the strap 14 at an optimum location for engaging the door handle when the bar 12 is mounted to the door frame.

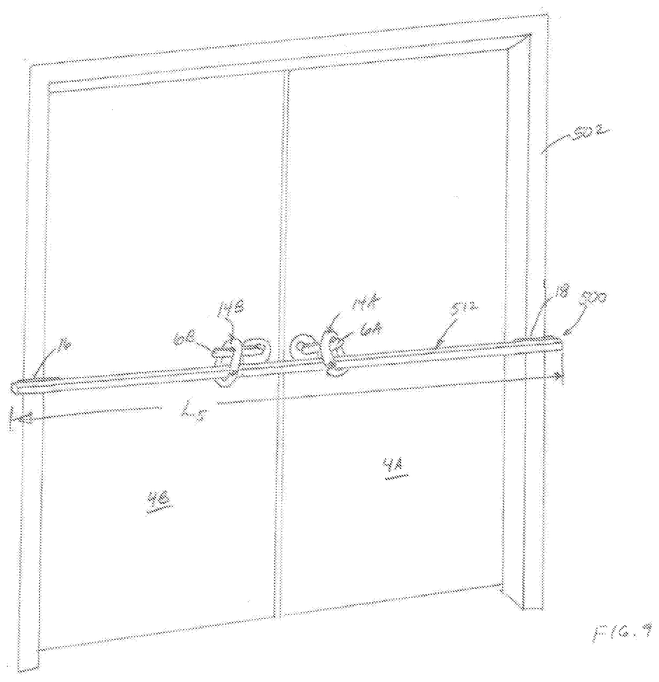

In some arrangements, the strap 14 may not have a continuous loop structure. For example, the strap 14 may include a length of material of any type that can be wrapped around the door handle and the bar 12 and secured by tying free ends of the strap 14 together in a knot and/or tying the strap 14 directly to the bar 12 using, for example, a knot or fastener. In still further examples, the strap 14 is replaced by a bracket, clip, or the like that extends from the bar 12 and engages the handle, and includes a relatively rigid structure that prevents the handle from rotating up or down, thereby effectively preventing the door from being opened. An example of such a handle securing member is described below with reference to FIG. 10.

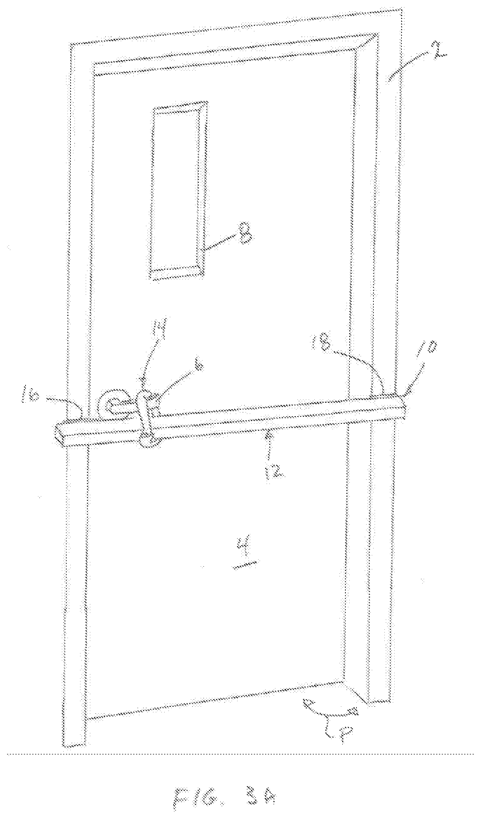

FIG. 3A illustrates the door restraint device 10 mounted to a door frame 2 using the bar retention members 16, 18. The strap 14 engages a handle 6 that operates to open and close the door 4 relative to the door frame 2. The door 4 may include a window 8. Typically, the door 4 pivots between open and closed positions in the pivot direction P. By restraining the handle 6 using the strap 14, which is mounted to the bar 12, and the bar retained in the horizontal position across the door frame 2 with the bar retention members 16, 18, the door 4 is limited in its ability to rotate about the pivot direction P. The length of strap 14 may be sufficiently small to prevent any opening of the door 12. In other embodiments, the length at strap 14 may permit limited opening of the door 4 in the pivot direction P, such as an amount sufficient for someone on the opposite side of the door 4 to extend a device through the crack provided between the door 4 and the door frame 2 to either remove the strap 14 from the handle 6 or cut or break the strap 14.

The ability to provide different lengths for the strap 14 may help accommodate different rules and regulations related to how doors are restrained, particularly in school settings, government buildings, and the like such that the door restraint device 10 cannot be used by an hostile intruder or other person in an improper way to either isolate themselves within the room or to trap themselves within a room with other people while preventing law enforcement or others from opening the door in any way.

FIG. 3B shows the door restraint device 10 mounted to one side of the door frame 2 when it is not in use restraining the door 4. The door restraint device 10 may be mounted to any portion of the door frame and arranged in a vertical position shown in FIG. 3B, mounted in a horizontal position across the top of the door 4 on the top or bottom side of the frame 2, positioned at least partially supported by the ground, or detached completely from the door frame and stored in another location such as at some location in close proximity to the door 4 for use in an emergency situation.

FIG. 4 illustrates another example door restraint 100 for use with a door 4 and handle 6. The door restraint 100 may include many of the same or similar features as described above with reference to door restraint 10. The door restraint 100 may additionally include a support leg 150. The support leg 150 may be used to hold a bar 112 in place adjacent to the door handle 6 in place of the first and second bar retention member 16, 18 described above. The support leg 150 may hold a bar 112 in a position proximate to the handle 6 such that to the strap 14 can be positioned around the handle 6 while the bar 112 extends horizontally across the door frame 2. The door restraint 100 may lean up against the door frame 2 during use.

Although a single support leg 150 is shown, other embodiments may include two or more support legs 150. The support legs 150 may be connected to each. The support leg 150 may be detachably mounted to the bar 112. For example, the support leg 150 may be secured to the bar 112 in the orientation shown in FIG. 4 (i.e., extending perpendicular to the bar 112) using a bracket, a free end of the support leg 150 inserted into an aperture formed in the bar 112, an adhesive, or a fastener. The support leg 150 may releasably connected to the bar 112 or permanently connected. In at least one example, the support leg 150 comprises a metal material and is welded to the bar 112, which also comprises a metal material.

When the door restraint 100 is not in use in the position shown in FIG. 4, it can be stored by leaning up against a wall adjacent to the door frame 2. In one example, the door restraint 100 is rotated 180 degrees so that the bar 112 is positioned on the ground and the support leg 150 can be tilted up against a wall. Alternatively, the door restraint 100, when not in use restraining the door in the position shown in FIG. 4, can be arranged with the support leg 150 across the horizontal top surface of the door frame 2 with the bar 112 extending along an outer side surface of the door frame 2. Alternatively, a wall-mounted bracket may be positioned adjacent to the door frame 2 and the door restraint 100 can be mounted to the wall bracket when not being used to retrain the door in the position shown in FIG. 4.

In one example, the support leg 150 has a length L₂ in the amount of about 24 inches to about 40 inches, and more particularly about 32 inches to about 40 inches. The door handle 6 is typically positioned at height from the ground surface of about 36 inches to about 38 inches. The support leg 150 has a length L₂ that positions the strap 14 at a height where it can engage with the handle 6 to assist with holding the door 4 closed or partially closed/opened.

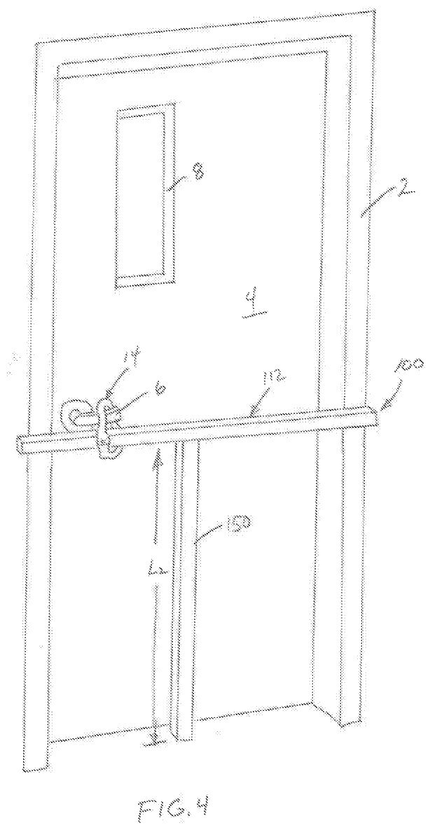

FIG. 5 illustrates a door restraint 200 that has a variable length L₄. The door restraint 100 includes a bar 212 having first and second telescoping members 252, 254. The first bar retention member 16 may be connected to the first telescoping member 252, and the second bar retention member 18 may be connected to the second telescoping member 254. The second telescoping member 254 is insertable into the first telescoping member 252. The strap 14 may be connected to the first telescoping member 252. Other arrangements are possible that include three or more telescoping members to provide a different range for length L₄.

The length L₄ may be adjustable by adjusting the longitudinal position of the telescoping members 252, 254 relative to each other. The door restraint 200 may be adjustable in length to accommodate different sized door frames. The door restraint 200 may provide advantages for manufacturing wherein a single door restraint 200 can be used with a variety of different door sizes that are typical schools, government buildings, commercial buildings, and homes. The door restraint 200 may include any of the other features and functionality of the door restraint embodiments 10, 100.

The first and second bar retention members 16, 18 may be replaced with or used in combination with other features used to hold the door restraint 200 against a door frame with the bar 212 oriented horizontally while the strap 14 is secured to the door handle 6. FIG. 6 illustrates an alternative to using the bar retention members 16, 18 to hold the bar 212 relative to the door frame. FIG. 6 illustrates a door restraint 300 that includes a bar 312, a strap 14, and mounting brackets 360, 362. The bar 312 may have a telescoping construction similar to the bar 212 described above. For example, the bar 312 may include first and second telescoping members 352, 354, wherein one of the telescoping members is insertable into the other telescoping member. The door restraint 300 may further include a length retention member 364 that holds the bar 312 at a given adjusted length. The length retention member 364 may include a high resistance material that is interposed between the telescoping members 352, 354 such that any relative length adjustment between the telescoping members 352, 354 is retained because of the resistance applied by the resistance member. In another example, a tension spring is positioned internal the first and second telescoping members 352, 354 and secured at opposing ends of the bar 312, wherein a user must apply an axially directed force to move the telescoping members 352, 354 away from each other to fit the mounting brackets 360, 362 around outer edges of the door frame 2, and releasing the applied force by the user permits the spring to move the mounting brackets 360, 362 toward each other to hold the bar 312 against the outer surfaces of the door frame 2. In another example, the length retention member 364 may include a fastener such as a set screw, an adhesive tape, or a compression bracket or lever that applies a force at the interface between the telescoping members 352, 354. In one example, the bar 312 comprises first and second telescoping members that have a round cross-sectional shape, and the length retention member 364 comprises a tightening member similar to that used for telescoping trekking poles that are length adjustable.

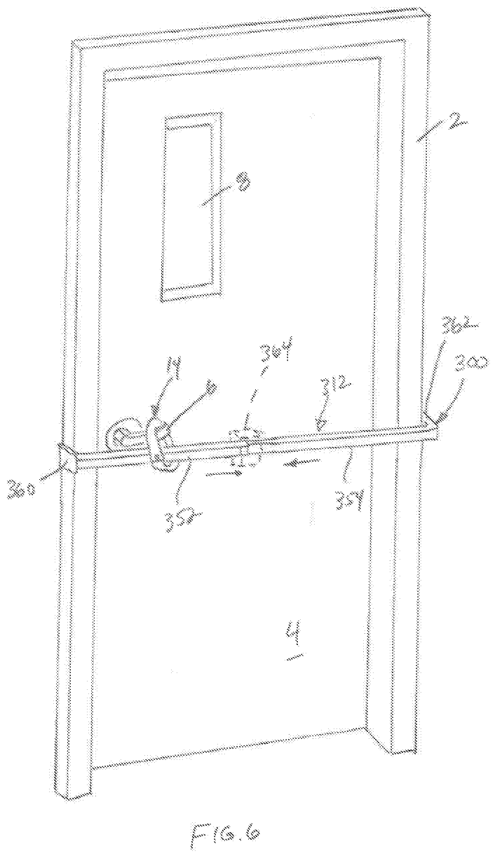

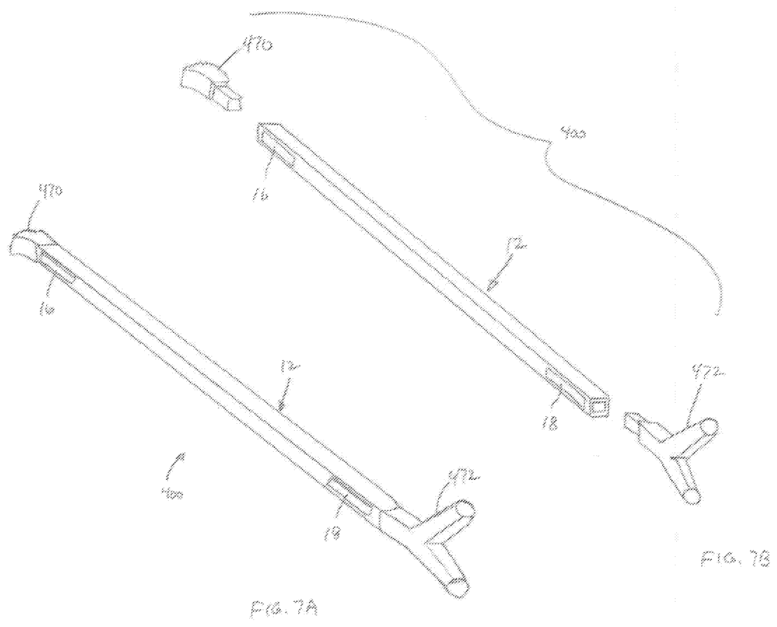

FIGS. 7A and 7B illustrate a door restraint 400 that can be used to prevent the door 4 from opening from an opposite side of the door 4. FIG. 8 shows the door restraint 400 with one end position on the ground and an opposite end engaging the door handle. The door restraint 400 functions as a door stop.

The door restraint 400 includes a bar 12, such as the bar described above with reference to door restraint 10. The bar 12 may include a hollow interior with open ends. The door restraint 400 may include a foot or bumper 470 that is inserted in one end of the bar 12, and a fork member 472 that is inserted into an opposite open end of the bar 12. In other arrangements, the foot 470 and/or fork member 472 are slid over an exterior surface at the opposing ends of bar 12 rather than being inserted into an interior of the bar 12. One consideration for inserting the foot 470 and fork member 472 into the hollow interior of bar 12 instead of sliding over an exterior is to avoid interference with the bar retention member 16, 18.

The foot 470 may comprise a gripping material such as rubber that is resistant to sliding on any variety of surfaces such as tile, carpet, cement, or hardwood. The foot 470 may include a contoured surface. The foot 470 may include a plurality of protrusions or tabs that provide increased gripping on the floor surface.

The fork member 472 may have a generally Y-shaped construction. The crotch of the Y-shape may engage a portion of the handle, such as that portion of the handle that extends through the door. The handle 472 may have other shapes, sizes, and features. For example, the fork member 472 may have a U-shaped construction, or include a feature that wraps around a portion of the door rather than simply abutting against a portion of the door handle. The fork member 472 may comprise a material that has high-strength properties. The fork member 472 may comprise materials or be coated with materials that limit scratching or damage to the door 4 and/or door handle 6 during use.

The foot 470 and fork member 472 may be provided as retrofit features to convert any one of the door restraints 10, 100, 200 to a door stop style restraint for use in the manner similar to what is shown in FIG. 8. The inclusion of the foot 470 and fork member 472 with the door restraints disclosed herein permit use of the door restraint 400 on either side of a door so as to be versatile for a variety of emergency situation to prevent someone from entering into a room or space regardless of the opening direction of the door.

FIG. 9 illustrates a door restraint 500 for use in restraining a double set of doors. The door restraint 500 may include a bar 512, straps 14A and 14B arranged and configured to engage with separate door handles 6A, 6B, respectively, and bar retention members 16, 18. The length L5 of the bar 512 may be sufficient to extend across an entire door frame 502 that is large enough to accommodate both doors 4A, 4B. In one example, the bar 512 may be an expandable length bar such as the bars 212, 312 described above with reference to FIGS. 5 and 6.

While separate straps 14A, 14B are shown for use with handles 6A, 6B, respectively, other embodiments are possible in which a single strap is sized and arranged to engage with both of the handles 6A, 6B. The straps 14A, 14B may be modified to work with other types of handles 6A, 6B, rather than the lever style shown in FIG. 9. For example, when an elongate, push-style handles are used with latching mechanisms that extend vertically up to the upper horizontal member of the door frame 502 and/or into a latch mechanism mounted to a floor, the strap may be able to extend through these vertically arranged latching mechanism or wrap around the horizontally arranged handles.

FIG. 10 illustrates another example door restraint 600 that includes a bar 612 mountable to a door frame 2 using bar retention members 16, 18, and a handle bracket 614 arranged to limit rotation of the handle 6. The handle bracket 614 may have any variety of constructions. Referring to FIG. 10A, handle bracket 614 may have a channel-type shape with upper and lower arms 613A, 613B that extend adjacent to top and bottom surfaces of the bar 612 to restrain rotation of the handle 6 (i.e., movement in the vertical direction V).

FIG. 10B shows another example handle bracket 614B that extends from a top surface of the bar 612 (or a bottom surface of the bar 612 in other embodiments) with an upper arm 613B, a connecting arm 617, and a lower arm 615B. The upper and lower arms 613B, 615B restrain rotating movement of the handle 6 in the vertical direction V.

The channel shape provided by the handle brackets 614A,s 614B may be inserted around the handle 6 as part of arranging the bar 612 in its horizontal position and mounted to the door frame 2. That is, the handle brackets 614A, 614B may be slid over the handle 6 in the horizontal direction (i.e., in the direction left to right shown in FIG. 10 to be inserted over the handle 6 prior to mounting the bar 612 to the door frame 2 using the bar retention member 16, 18. In the arrangement of FIG. 10B, the handle bracket 614B may be mounted to the handle 6 by first inserting the handle 6 through the gap G while the connecting arm 617 is oriented facing upward, and then rotating the bar 612 into the position shown in FIG. 10B, followed by connecting the bar retention member 16, 18 to the door frame 2.

Other handle bracket configurations are possible to restrain rotation of the handle 6 in the upward direction, the downward direction, or both the upward and downward directions. The handle bracket 614 may be mounted to the bar 12 using any of a variety of connection methods such as, for example, welding, adhesives, interference fit connections, co-molding, or integral formation as a single piece during formation of the door restraint 600.

FIG. 11 illustrates an example strap 714 that provides an adjustable sized loop. The strap 714 includes first and second ends 740, 742, and a buckle 746. The buckle 746 is mounted to the first end 740 and the second end 742 is inserted through the buckle 746. The buckle 746 may provide a one-way movement of the free end 742 to reduce the size of the loop provided by strap 714. Actuating the buckle 746 may permit movement of the free end 742 in an opposite direction through the buckle 746 to increase the size of the loop, or may be operable to ratchet the strap through the buckle 746.

Other types of buckles or other types of releasable fasteners may be used. When using other connecting members besides a strap, such as a cable, rope, chain, or the like, different types of buckles or fasteners may be used to provide adjustment of the size of the loop and/or otherwise provide adjustability related to securing the door handle 6 relative to the bar of the restraint device. In some examples, the strap 714 may include a loop that wraps around a door handle, and the free end 742 is connected to the bar (i.e., instead of a portion of the loop being connected to the bar). In some arrangements, the free end 742 may be manually connected to the bar when connecting the door restraint to a door using, for example, a knot tied by the user.

FIGS. 12A-12D illustrate various cross-sectional shapes possible for the bar of the door restraints disclosed herein. The cross-sectional shapes and configurations shown in FIGS. 12A-12D are exemplary only and not intended to be exhaustive.

FIG. 12A illustrates an example bar 812A having a rectangular cross-sectional shape and a hollow interior. A bar retention member 16 may be positioned internal the bar 812A, such as mounted to one of the interior surfaces of the hollow interior 832A. In some examples, multiple bar retention members 16 may be positioned along multiple interior surfaces of the hollow interior 832A. In other examples, the hollow interior 832A may be filled with the bar retention member 16. The bar retention member 16 may include a magnetic material that provides a magnetic force that is sufficient to act through the walls of the bar 812 to secure the bar 812 to a door frame. In other embodiments, the hollow interior 832A is filled with another material such as a material that provides added strength for the bar 812A.

FIG. 12B shows a bar 812B that has a solid construction. A bar retention member 16 may be positioned along one or more of the exterior surfaces of the solid bar 812B

FIG. 12C shows a bar 812C having a triangular cross-sectional shape. The bar 812C may have a hollow construction with a hollow interior 832C, or may have a solid construction. A bar retention member 16 may be positioned along one or more of the exterior surfaces of the bar 812C.

FIG. 12D shows a bar 812D having a circular cross-sectional shape with a hollow interior 832D. The bar retention member 16 may be positioned at any location around the outer perimeter of the bar 812D. A connecting material such as an adhesive, weld, or the like (illustrated as feature 17) may be used to secure the relatively planar shaped bar retention member 16 at to the contoured exterior surface of the bar 812D. In any of the examples shown in FIGS. 12A-12C, multiple bar retention member 16 may be positioned around the perimeter of the bare, within an interior of the bar, or embedded within material of the bar.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” as may be used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (e.g., A and B and C).

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A door restraint device, comprising:
a support bar configured to be arranged horizontally and extend across and be supported against a door frame proximate a handle of a door positioned in the door frame;
a strap connected to the support bar and sized to connect to a handle of the door.

2. The door restraint device of claim 1, further comprising at least one bar retention member mounted to the support bar and configured to secure the support bar to the door frame.

3. The door restraint device of claim 1, wherein the at least one bar retention member comprises magnetic material.

4. The door restraint device of claim 1, wherein the at least one bar retention member includes a first magnet positioned at a first end of the support bar and a second magnet positioned at an opposite second end of the support bar.

5. The door restraint device of claim 1, wherein the strap have a loop shape.

6. The door restraint device of claim 1, wherein the strap is connected to the support bar with a fastener.

7. The door restraint device of claim 1, wherein the support bar has a hollow construction.

8. The door restraint device of claim 1, wherein the support bar comprises a metal material.

9. The door restraint device of claim 1, wherein the strap comprises a fabric material.

10. The door restraint device of claim 1, wherein the strap includes a buckle that provides length adjustment for the strap.

11. A door restraint device, comprising:
an elongate metal bar;
first and second magnets mounted to the bar and configured to releasably secure the bar to respective right and left sides of a metal door frame when the bar is oriented horizontally across a width of the door frame;
a strap connected to the bar and configured to wrap around a door handle of a door that is mounted to and arranged in a closed position relative to the door frame, the door restrain device configured to limit opening of the door in a first direction.

12. The door restraint device of claim 11, further comprising a foot member mounted to a first end of the metal bar and a handle fork mounted to a second end of the bar, the foot member configured to engage a floor surface and the handle fork configured to engage the door handle to restrict opening of the door in a second direction.

13. The door restraint device of claim 11, wherein the strap has a fixed length.

14. A method of operating door restraint device, comprising:
providing a door restraint device having a cross bar, a handle connecting member mounted to the bar, and at least one bar retention member connected to the bar;
orienting the cross bar across a width of a door frame;
securing the cross bar to opposite sides of the door frame with the at least one bar retention member;
connecting the handle connecting member to a handle of the door.

15. The method of claim 14, wherein the at least one bar retention member is a magnet, and securing the cross bar to the door frame includes releasably connecting the magnet to the door frame.

16. The method of claim 14, wherein the handle connecting member includes a loop of material, and connecting the handle connecting member to the handle includes positioning a portion of the handle connecting member around a free end of the handle.

17. The method of claim 14, wherein the handle connecting member includes a strap, and connecting the handle connecting member to the handle includes wrapping a portion of the handle connecting member around the handle.

18. The method of claim 14, wherein the handle connecting member includes a bracket, the bracket arranged to limit rotation of the handle in at least one direction to present unlatching of the handle.

19. The method of claim 14, further comprising adjusting a length of the cross bar before securing cross bar to the door frame.

20. The method of claim 14, further comprising adjusting a length of the handle connecting member after connecting the handle connecting member to the door handle to adjust an amount the door is openable relative to the door frame.
